(19) United States
(12) Patent Application Publication
(10) Pub. No.: US 2006/0221397 A1
(43) Pub. Date: Oct. 5, 2006

(54) METHOD AND APPARATUS FOR FORMING IMAGE USING EDGE INFORMATION OF IMAGE

(76) Inventor: Woo-jun Chung, Suwon-si (KR)

Correspondence Address: STANZIONE & KIM, LLP, 919 18TH STREET, N.W., SUITE 440, WASHINGTON, DC, 20006, US

(21) Appl. No.: 11/277,172

(22) Filed: Mar. 22, 2006

(30) Foreign Application Priority Data
Apr. 1, 2005 (KR) 2005-27492

(51) Int. Cl. H04N 1/40

(52) U.S. Cl. 358/3.03; 358/3.27

(57) ABSTRACT

A method and apparatus to form an image by half-toning a plurality of areas of an input image using different multi-tone patterns with reference to edge information regarding edge areas and flat areas detected from the input image. The method includes detecting edge areas and flat areas of an input image, half-toning the input image by applying different multi-tone patterns to the detected edge and flat areas, and generating a half-toned image for the input image by integrating the edge and flat areas that have been half-toned with the different multi-tone patterns.

### CROSS-REFERENCE TO RELATED APPLICATIONS

This application claims priority from Korean Patent Application No. 2005-27492, filed on Apr. 1, 2005, in the Korean Intellectual Property Office, the disclosure of which is incorporated herein in its entirety by reference.

### BACKGROUND OF THE INVENTION

1. Field of the Invention

The present general inventive concept relates to a method and apparatus for forming an image, and more particularly, to a method and apparatus for forming an image by detecting edge areas and flat areas of an input image and half-toning the detected edge and flat areas by applying different multi-toned patterns to the detected edge and flat areas.

2. Description of the Related Art

In order to print a scanned image or an image displayed by a display device using a printing device, the scanned image or the displayed image must be converted into a gray scale image having a gray scale value between 0 and 255, and then the gray scale image must be converted into a binary image. The conversion of the gray scale image into the binary image is called half-toning. A half-toned image is perceived as a continuous gray scale image obtained through low pass filtering by the human eyes and the human brain. The half-toned image is spatially integrated when perceived due to the functions of the human eyes and the human brain.

FIG. 1 is a flowchart illustrating a conventional method of forming an image through multilevel half-toning. Referring to FIG. 1, in multilevel half-toning, one dot can be divided into a plurality of sub-dots, and then a variety of gray scale levels can be represented based on the sub-dots, whereas in binary-level half-toning, one dot is represented by a binary value of 0 or 1.

In operation 110, an image is converted into a gray scale image, and the gray scale image is input. In operation 120, a plurality of screen masks are generated by using a 1-bit screen mask. The 1-bit screen mask is a matrix that has values from 0 to 255 and thus can efficiently dither a gray scale image. A number of screen masks “N” corresponding to the number of gray scale levels desired to be rendered are generated by scaling the 1-bit screen mask to a predetermined value. In operation 130, a multilevel half-toned image is generated by using the screen masks generated in operation 120. In detail, the gray scale image is compared with each of the screen masks generated in operation 120, thereby generating on or off data for each sub-dot. If the non data is generated for a sub-dot, the sub-dot will be printed in black. If the off data is generated for a sub-dot, the sub-dot will not be printed. Thereafter, the on or off data generated for each sub-dot are integrated, thereby forming a final multilevel half-toned image.

In the conventional method as illustrated in FIG. 1, however, the multilevel half-toned image does not satisfy the hardware characteristics of a laser printer. Thus, artifacts may be undesirably generated between portions of the multilevel half-toned image when printing the multilevel half-toned image in such a manner that one dot is classified into a plurality of dots. Therefore, the conventional method as illustrated in FIG. 1 may not be able to fully render a variety of levels of gray scale.

### SUMMARY OF THE INVENTION

The present general inventive concept provides a method of forming an image by detecting edge areas and flat areas of an input image and half-toning each of the detected edge and flat areas by applying different multi-tone patterns with reference to edge information regarding the detected edge and flat areas.

The present general inventive concept also provides an apparatus to form an image by detecting edge areas and flat areas from the image and half-toning each of the detected edge and flat areas using multi-tone patterns with reference to edge information regarding the detected edge and flat areas.

Additional aspects and advantages of the present general inventive concept will be set forth in part in the description which follows and, in part, will be obvious from the description, or may be learned by practice of the general inventive concept.

The foregoing and/or other aspects and utilities of the present general inventive concept may be achieved by providing a method of forming an image, the method including detecting edge areas and flat areas of an input image, half-toning the input image by applying different multi-tone patterns to the detected edge and flat areas, and generating a half-toned image for the input image by integrating the edge and flat areas that have been half-toned with the different multi-tone patterns.

The half-toning may include determining the multi-tone patterns for the respective ones of the edge and flat areas of the input image based on values output for the areas of the input image from the edge detection unit, and half-toning the areas of the input image using the determined multi-tone patterns.

The determining may include determining multi-tone pattern constants for the areas of the input image based on the values output from the edge detection unit, and determining the multi-tone patterns for the areas of the input image based on the determined multi-tone pattern constants.

At least one edge area of the input image may be half-toned using a partial dot pattern corresponding to one of the multi-tone pattern constants determined for the at least one edge area of the input image, and at least one flat area of the input image may be half-toned using a full dot pattern corresponding to another one of the multi-tone pattern constants determined for the at least one flat area of the input image.

An area between the at least one edge area and the at least one flat area of the input image may be half-toned using a mixed dot pattern, which is a mixture of the partial dot pattern and the full dot pattern corresponding to one of the multi-tone pattern constants between the multi-tone pattern constant of the at least one edge area and the multi-tone pattern constant of the at least one flat area.

The foregoing and/or other aspects and utilities of the present general inventive concept may also be achieved by providing an image-forming apparatus, comprising an edge detection unit to detect edge areas and flat areas of an input image, an image processing unit to half-tone the input image by applying different multi-tone patterns to the detected edge and flat areas, and an integration unit to generate a half-toned image for the input image by integrating the edge and flat areas that have been half-toned with the different multi-tone patterns by the image processing unit.

The edge detection unit may detect the edge areas from the input image based on a variation in brightness or color of the input image.

The image processing unit may include a multi-tone pattern determiner to determine the multi-tone patterns for the edge and flat areas of the input image based on values output from the edge detection unit for the areas of the input image by the edge detection unit, and a half-toner to half-tone the areas of the input image using the determined multi-tone patterns.

The multi-tone pattern determiner may include: a first determiner to determine multi-tone pattern constants for the areas of the input image based on the output values output from the edge detection unit, and a second determiner to determine the multi-tone patterns for the areas of the input image based on the determined multi-tone pattern constants.

The half-toner may include: a screen generator to generate n-number of screens that can represent n-number of gray scale levels based on the multi-tone pattern constants, a comparator to compare the input image with each of the n-number of screens and to generate comparison results, and an image former to half-tone the areas of the input image using the multi-tone patterns based on the comparison results provided by the comparator.

The foregoing and/or other aspects and utilities of the present general inventive concept may also be achieved by providing an image-forming method comprising detecting at least one edge area of an input image, applying a first multi-toned pattern to the detected at least one edge area, detecting at least one flat area of the input image, applying a second multi-toned pattern to the detected at least one flat area, and generating the image by integrating the multi-toned patterns. The first multi-toned pattern may be a partial dot pattern, and the second multi-toned pattern may be a full dot pattern. The method may further comprise detecting at least one intermediate area between the at least one edge area and the at least one flat area, and applying a third multi-toned pattern to the detected at least one intermediate area. The third multi-toned pattern may be a mixture of a partial dot pattern and a full dot pattern.

The foregoing and/or other aspects and utilities of the present general inventive concept may also be achieved by providing a half-toned image comprising at least one edge area represented by a partial dot pattern and at least one flat area represented by a full dot pattern. The image may further comprise at least one intermediate area between the at least one edge area and the at least one flat area. The at least one intermediate area may be represented by a mixture of a partial dot pattern and a full dot pattern.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a flowchart illustrating a conventional method of forming an image through multilevel half-toning;

FIG. 2 is a flowchart illustrating a method of forming an image by performing multi-tone half-toning using edge information of an input image according to an embodiment of the present general inventive concept;

FIG. 3 is a flowchart illustrating operation 230 of the method of FIG. 2;

FIG. 4 is a table illustrating a variety of operators used in an edge detection unit according to an embodiment of the present general inventive concept;

FIGS. 5A, 5B, and 5C are diagrams illustrating a partial dot pattern, a full dot pattern, and a mixed dot pattern, respectively;

FIGS. 6A, 6B, and 6C are diagrams illustrating an input gray scale image, an image obtained by processing the input gray scale image using an edge detection unit, and an image obtained by half-toning edge areas and flat areas detected from the input gray scale image using different multi-tone patterns;

FIG. 7 is a block diagram of an apparatus to form an image by performing multi-tone half-toning using edge information regarding the image according to an embodiment of the present general inventive concept;

FIG. 8 is a detailed block diagram of the image processing unit 720 of the apparatus of FIG. 7; and

FIG. 9 is a table illustrating an increase of a value of a dot in accordance with a multi-tone pattern constant k.

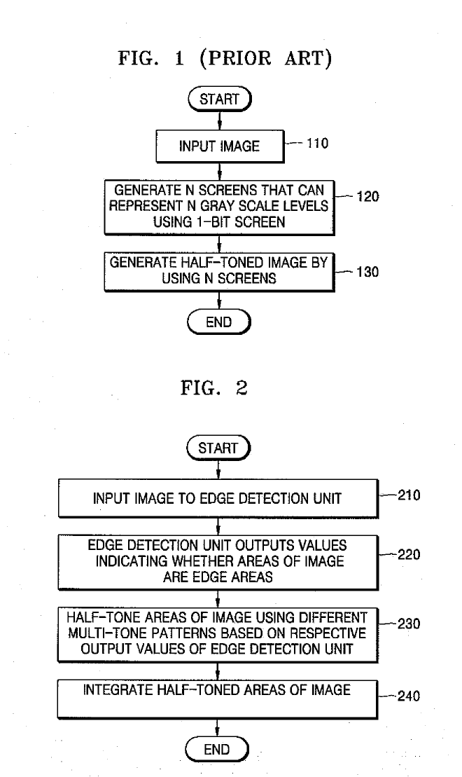

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

FIG. 2 is a flowchart illustrating a method of forming an image by performing multi-tone half-toning using edge information of an image according to an embodiment of the present general inventive concept. Referring to FIG. 2, in operation 210, a gray scale image is input to an edge detection unit. The input gray scale image is an image having a gray scale value between 0 and 255 into which an image having a variety of brightness levels is converted. In operation 220, the edge detection unit determines whether each of a plurality of areas of the input gray scale image is an edge area or a flat area, and outputs a value indicating whether each of the plurality of areas of the input gray scale image is an edge area or a flat area.

Edges are defined as lines determining contours of an object rendered in an image and thus are an essential part of image processing because they characterize the image. The edge detection unit detects a discontinuity between a pair of adjacent areas of the input gray scale image having different brightnesses. In order to detect portions of the input gray scale image where brightness dramatically changes, the edge detection unit may use a differentiation operation method. The differentiation operation method detects an edge area of a gray scale image based on a variation between the adjacent areas in a brightness function. A template matching method detects an edge area of a gray scale image by comparing a reference pattern with each of a plurality of portions of the gray scale image and selecting one of the plurality of portions that matches the reference pattern the closest.

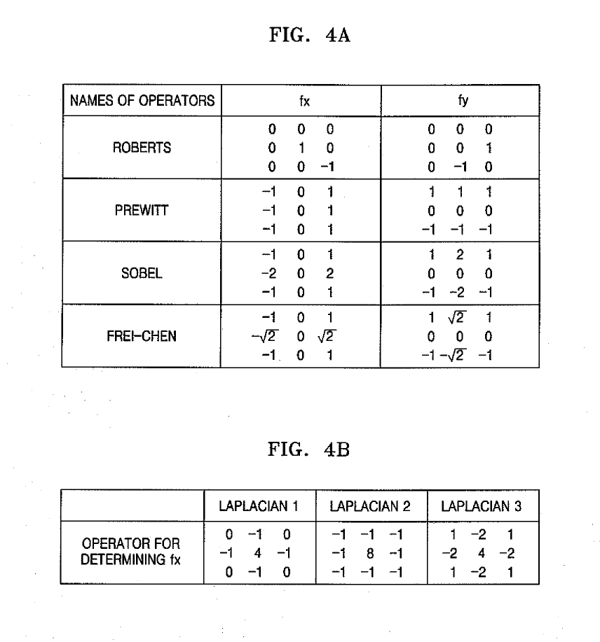

Examples of the differentiation operation method include a gradient method and a Laplacian method. Examples of a gradient operator used by the edge detection unit include Roberts operator, Prewitt operator, Sobel operator, and Frei-Chen operator. Examples of a Laplacian operator used by the edge detection unit include Laplacians 1 through 3. FIG. 4 illustrates a variety of gradient operators and Laplacian operators set forth herein. The edge detection unit can also detect an edge of a gray scale image by using an operator other than those set forth herein, and thus is not limited to gradient and Laplacian operators.

In short, when a gray scale image is input, the edge detection unit outputs a value indicating whether a predetermined area of the input gray scale image is an edge area or a flat area by using one or more operators.

Referring to FIG. 2, in operation 230, a multi-tone pattern is determined for each of the plurality of areas of the input gray scale image based on the values output from the edge detection unit, and the input gray scale image is half-toned based on the determined multi-tone patterns.

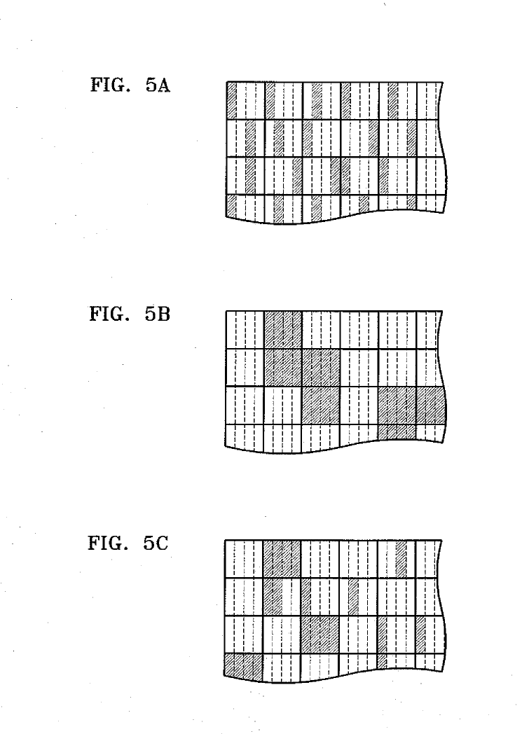

Examples of a multi-tone pattern include a partial dot pattern, a full dot pattern, and a mixed dot pattern. FIGS. 5A, 5B, and 5C are diagrams illustrating a partial dot pattern, a full dot pattern, and a mixed dot pattern, respectively. Referring to FIGS. 5A through 5C, one dot is divided into four sub-dots and thus can represent up to four gray scale levels. An edge area of a gray scale image can be sharply rendered by using the partial dot pattern, and a flat area of the gray scale image can be smoothly rendered by using the full dot pattern. An area between the edge and flat areas of the gray scale image can be naturally rendered by using the mixed dot pattern, which is a mixture of the full dot pattern and the full dot pattern.

Referring to FIG. 2, in operation 240, the plurality of areas of the input gray scale image are half-toned with reference to the respective multi-tone patterns, and a final multi-tone half-toned image is formed by integrating the half-toned areas of the input gray scale image.

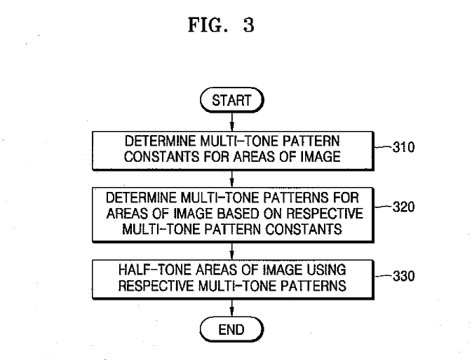

FIG. 3 is a flowchart illustrating operation 230 of the method of FIG. 2. Referring to FIG. 3, in operation 310, a multi-tone pattern constant K is determined for each of the plurality of areas of the input gray scale image. The multi-tone pattern constants K are determined based on the values output for the respective areas of the input gray scale image from the edge detection unit in operation 220 of FIG. 2. The multi-tone pattern constants K may be stored in a memory and thus may be mapped to the respective output values of the edge detection unit.

In operation 320, multi-tone patterns are determined for the plurality of areas of the input gray scale image based on the respective multi-tone pattern constants determined in operation 310. In operation 330, the plurality of areas of the input gray scale image are half-toned using the multi-tone patterns determined in operation 320. For example, if the edge detection unit outputs a value of 50 for a predetermined area of the input gray scale image, a multi-tone pattern constant K for the predetermined area of the input gray scale image is set to 4, and the predetermined area of the input gray scale image is half-toned using a full dot pattern. If the edge detection unit outputs a value of 400 for the predetermined area of the input gray scale image, the multi-tone pattern constant K for the predetermined area of the input gray scale image is set to 256, and the predetermined area of the input gray scale image is half-toned using a partial dot pattern. If the edge detection unit outputs a value of 200 for the predetermined area of the input gray scale image, the multi-tone pattern constant K for the predetermined area of the input gray scale image is set to 32, and the predetermined area of the input gray scale image is half-toned using a mixed dot pattern, which is with a mixture of the full dot pattern and the partial dot pattern.

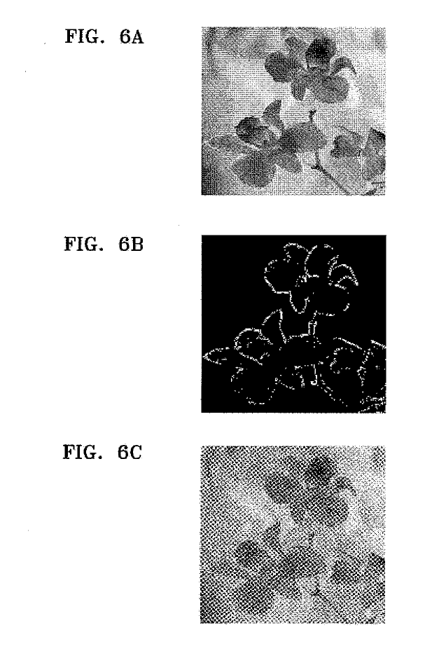

FIGS. 6A, 6B, and 6C are diagrams illustrating an input gray scale image, an image obtained by processing the input gray scale image using an edge detection unit, and an image obtained by half-toning the input gray scale image so that edge areas and flat areas of the input gray scale image are half-toned with different multi-tone patterns. Specifically, FIG. 6B presents an image obtained by processing the gray scale image of FIG. 6A using an edge detection unit that uses Laplacian 2. White portions of the image as presented in FIG. 6B are edges.

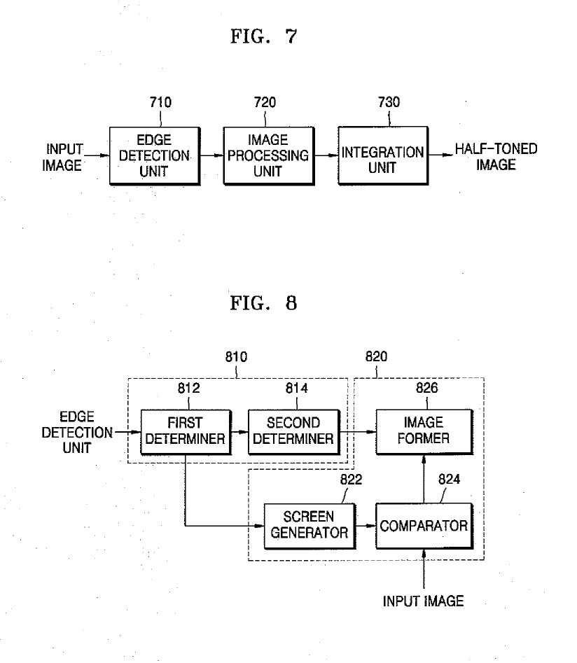

FIG. 7 is a block diagram of an apparatus for forming an image by performing multi-tone half-toning using edge information of the image according to an embodiment of the present general inventive concept. Referring to FIG. 7, the apparatus includes an edge detection unit 710, an image processing unit 720, and an integration unit 730. The edge detection unit 710 detects edge areas and flat areas of an input gray scale image having a gray scale value between 0 and 255. In order to detect portions of the input gray scale image where brightness dramatically changes, the edge detection unit 710 may use a differentiation operation method and a template matching method. In addition, when using the differentiation operation method, the edge detection unit 710 may use a gradient operator or a Laplacian operator.

The image processing unit 720 can precisely and naturally half-tone the input gray scale image by applying different multi-tone patterns to the detected edge and flat areas. The integration unit 730 generates a half-toned image by integrating the edge and flat areas that have been half-toned using the different multi-tone patterns. The half-toned image is compressed by using a compression method, such as a Joint Bi-level Image Experts Group (JBIG) compression method, a JBIG2 compression method, or a modified MR (MMR) method, and the compressed image is transmitted to a printing device (not shown). Thereafter, the printing device decompresses the compressed image and then prints the decompressed image.

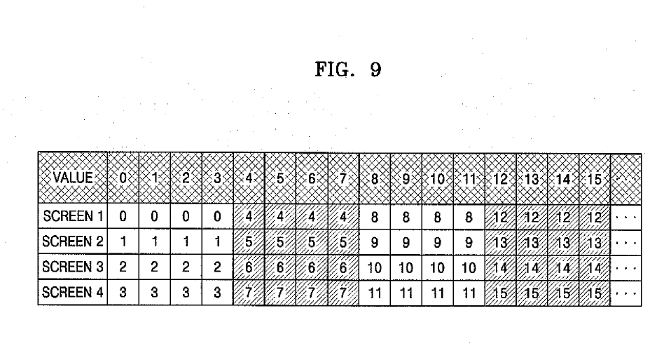

FIG. 8 is a detailed block diagram illustrating the image processing unit 720 of the apparatus of FIG. 7. Referring to FIGS. 7 and 8, the image processing unit 720 includes a multi-tone pattern determiner 810 and a half-toner 820. The multi-tone pattern determiner 810 determines a multi-tone pattern for each of a plurality of areas of an input gray scale image based on values output for the plurality of areas of the input gray scale image from the edge detection unit 710 of FIG. 7. The half-toner 820 half-tones the input gray scale image using the multi-tone patterns determined for the plurality of areas of the input gray scale image.

The multi-tone pattern determiner 810 includes a first determiner 812 and a second determiner 814. The first determiner 812 determines multi-tone pattern constants K for the plurality of areas of the input gray scale image based on the output values output from the edge detection unit. The second determiner 814 determines multi-tone patterns for the plurality of areas of the input gray scale image based on the multi-tone pattern constants K determined by the first determiner 812.

The half-toner 820 includes a screen generator 822, a comparator 824, and an image former 826. The screen generator 822 generates n-number of screens for rendering n-number of gray scale levels based on the multi-tone pattern constants K determined by the first determiner 812. The comparator 824 compares the input gray scale image with each of the n-number of screens generated by the screen generator 822, and generates comparison results. Then, the image former 826 half-tones the input gray scale image based on the comparison results provided by the comparator 824 and based on the multi-tone patterns determined by the second determiner 814.

FIG. 9 is a table illustrating an increase of a value of a dot in accordance with a multi-tone pattern constant k. Referring to FIG. 9, the screen generator 822 of FIG. 8 generates first through fourth screens that can represent 4 gray scale levels by using Equations (1) through (4), respectively:
Screen 1=(int)(S/K)K+(int)(S% K)/M (1)
Screen 2=Screen 1+(int)K/M (2)
Screen 3=Screen 2+(int)K/M (3)
Screen 4=Screen 3+(int)K/M (4)
where K indicates the number of reiterations, M indicates the number of sub-dots into which one dot can be divided, and S is a value to which a 1-bit screen is set.

As K increases, more portions of an input gray scale image are half-toned using a partial dot pattern instead of a full dot pattern so that the input gray scale image is multi-tone half-toned.

As described above, edge areas and flat areas are detected from an input gray scale image, and their characteristcs can be precisely represented.

In addition, it is possible to precisely half-tone the input gray scale image by clustering dots of a flat area of the input gray scale image, which need to be represented with as many tones as possible, and dispersing dots of an edge area of the input gray scale image, which need to be represented as clearly as possible.

The present general inventive concept can be realized as computer-readable code written on a computer-readable recording medium. The computer-readable recording medium may be any type of recording device in which data is stored in a computer-readable manner. Examples of the computer-readable recording medium include a ROM, a RAM, a CD-ROM, a magnetic tape, a floppy disc, an optical data storage, and a carrier wave (e.g., data transmission through the Internet). The computer-readable recording medium can be distributed over a plurality of computer systems connected to a network so that computer-readable code is written thereto and executed therefrom in a decentralized manner. Functional programs, code, and code segments needed for realizing the present invention can be easily construed by one of ordinary skill in the art.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A method of forming an image, the method comprising:
detecting edge areas and flat areas of an input image;
half-toning the input image by applying different multi-tone patterns to the detected edge and flat areas; and
generating a half-toned image for the input image by integrating the edge areas and the flat areas that have been half-toned with the different multi-tone patterns.

2. The method of claim 1, wherein the detecting of the edge areas and flat areas comprises:
inputting the input image to an edge detection unit to detect the edge areas and the flat areas of the input image; and
outputting values from the edge detection unit indicating whether each of a plurality of areas of the input image is an edge area or a flat area.

3. The method of claim 2, wherein the detecting of the edge areas and flat areas comprises detecting the edge areas from the input image based on a variation between adjacent areas in the brightness or color of the input image in the edge detection unit.

4. The method of claim 2, wherein the half-toning of the input image comprises:
determining multi-tone patterns for the plurality of areas of the input image based on the values output for the plurality of areas of the input image from the edge detection unit; and
half-toning the plurality of areas of the input image using the determined multi-tone patterns.

5. The method of claim 4, wherein the determining of the multi-tone patterns comprises:
determining multi-tone pattern constants for the plurality of areas of the input image based on the values output from the edge detection unit; and
determining the multi-tone patterns for the plurality of areas of the input image based on the determined multi-tone pattern constants.

6. The method of claim 5, wherein the half-toning of the input image comprises half-toning at least one edge area of the input image using a partial dot pattern corresponding to one of the multi-tone pattern constants determined for the at least one edge area of the input image, and at least one flat area of the input image using a full dot pattern corresponding to another one of the multi-tone pattern constants determined for the at least one flat area of the input image.

7. The method of claim 6, wherein the generating of the half-tone miage comprises half-toning an area between the at least one edge area and the at least one flat area of the input image using a mixed dot pattern, which is a mixture of the partial dot pattern and the full dot pattern corresponding to another one of the multi-tone pattern constants between the multi-tone pattern constant of the at least one edge area and the multi-tone pattern constant of the at least one flat area.

8. A computer-readable recording medium comprising a computer program to execute the method of detecting edge areas and flat areas of an input image, half-toning the input image by applying different multi-tone patterns to the detected edge and flat areas, and generating a half-toned image for the input image by integrating the edge areas and the flat areas that have been half-toned with the different multi-tone patterns.

9. An image-forming apparatus, comprising:
an edge detection unit to detect edge areas and flat areas of an input image;
an image processing unit to half-tone the input image by applying different multi-tone patterns to the detected edge and flat areas; and
an integration unit to generate a half-toned image for the input image by integrating the edge and flat areas that have been half-toned with the different multi-tone patterns by the image processing unit.

10. The apparatus of claim 9, wherein the edge detection unit detects the edge areas of the input image based on a variation in the brightness or color of the input image.

11. The apparatus of claim 10, wherein the image processing unit comprises:
a multi-tone pattern determiner to determine multi-tone patterns for the edge areas and the flat areas of the input image based on values output from the edge detection unit for the edge areas and the flat areas of the input image; and
a half-toner to half-tone the edge areas and the flat areas of the input image using the determined multi-tone patterns.

12. The apparatus of claim 11, wherein the multi-tone pattern determiner comprises:
a first determiner to determine multi-tone pattern constants for the edge areas and the flat areas of the input image based on the output values output from the edge detection unit; and
a second determiner to determine the multi-tone patterns for the edge areas and the flat areas of the input image based on the determined multi-tone pattern constants.

13. The apparatus of claim 12, wherein the half-toner comprises:
a screen generator to generate n-number of screens that can represent n-number of gray scale levels based on the multi-tone pattern constants;
a comparator to compare the input image with each of the n-number of screens and to generate comparison results; and
an image former to half-tone the edge areas and the flat areas of the input image using the determined multi-tone patterns based on the comparison results provided by the comparator.

14. The apparatus of claim 13, wherein at least one edge area of the input image is half-toned using a partial dot pattern corresponding to a multi-tone pattern constant determined for the at least one edge area of the input image, and at least one flat area of the input image is half-toned using a full dot pattern corresponding to a multi-tone pattern constant determined for the at least one flat area of the input image.

15. The apparatus of claim 14, wherein an area between the at least one edge area and the at least one flat area of the input image is half-toned using a mixed dot pattern, which is a combination of the partial dot pattern and the full dot pattern corresponding to a multi-tone pattern constant between the multi-tone pattern constant of the at least one edge area and the multi-tone pattern constant of the at least one flat area.

16. An image-forming method, comprising:
detecting at least one edge area of an input image;
applying a first multi-toned pattern to the detected at least one edge area to form a first toned image;
detecting at least one flat area of the input image;
applying a second multi-toned pattern to the detected at least one flat area to form a second toned image; and
generating an image by integrating the first and second toned images corresponding to the multi-toned patterns.

17. The image-forming method of claim 16, wherein:
the first multi-toned pattern is a partial dot pattern; and
the second multi-toned pattern is a full dot pattern.

18. The image-forming method of claim 16, further comprising:
detecting at least one intermediate area between the at least one edge area and the at least one flat area; and
applying a third multi-toned pattern to the detected at least one intermediate area to form a third toned image.

19. The image-forming method of claim 18, wherein third multi-toned pattern is a mixture of a partial dot pattern and a full dot pattern.

20. A half-toned image generated by the method of claim 16, wherein the image comprises:
at least one intermediate area between the at least one edge area and the at least one flat area to be represented by a mixture of a partial dot pattern and a full dot pattern.
